(19) United States
(12) Patent Application Publication
(10) Pub. No.: US 2025/0308502 A1
(43) Pub. Date: Oct. 2, 2025

(54) ACTIVE VIBRATION NOISE CONTROLLER

(71) Applicant: HONDA MOTOR CO., LTD., Tokyo (JP)

(72) Inventors: Xun WANG, Wako-shi (JP); Toshio INOUE, Wako-shi (JP)

(21) Appl. No.: 19/062,661

(22) Filed: Feb. 25, 2025

(30) Foreign Application Priority Data
Mar. 29, 2024 (JP) 2024-058284

(51) Int. Cl. G10K 11/178

(52) U.S. Cl. CPC G10K 11/17823; G10K 11/17825; G10K 11/17881; G10K 2210/12821; G10K 2210/3026; G10K 2210/3027; G10K 2210/3028

(57) ABSTRACT

A noise controller comprises a speaker which outputs a canceling sound for canceling noise; an error microphone which generates an error signal from the noise and the canceling sound; and a reference microphone which detects reference signals. The noise controller comprises: a removal filter which is adaptively updated based on a current one of the reference signals and a previous one of the reference signal; and a filter processing unit which generates the canceling sound.

### BACKGROUND OF THE INVENTION

### 1. Field of the Invention

The present invention relates to an active vibration noise controller.

### 2. Description of the Related Art

Conventionally, an active noise controller includes: a canceling sound output device which outputs a canceling sound for cancelling noise; a plurality of noise microphones which generate a plurality of noise signals based on noise; and a controller which controls the canceling sound output device based on the plurality of noise signals.

The controller obtains the plurality of noise signals outputted from the plurality of noise microphones, and selects a reference signal corresponding to the noise and an error signal corresponding to an error between the noise and the canceling sound from among the plurality of noise signals.

Then, a corrected reference signal is generated by removing a component of the canceling sound from the reference signal, and a control signal for controlling the canceling sound output device is generated based on the corrected reference signal (see, for example, Patent Literature 1, and the like).
Patent Literature 1: JP2023-144581A

### SUMMARY OF THE INVENTION

However, in the case where a microphone is disposed in a headrest, the microphone also comes near the mouth of the occupant. For this reason, the microphone becomes likely to detect the conversation voice of the occupant. Particularly, in the case of utilizing a microphone signal as a reference signal, a control output generated from the microphone signal contains a voice component. For this reason, when the sound is outputted from a speaker, there is a possibility that an echo of the voice is generated inside the vehicle interior and gives discomfort to the occupant.

In addition, in the case of calculating a voice component to be removed from a reference signal which has been caught by a microphone, it is necessary to extract the voice component in a frequency band and conduct complicated convolution calculation, which increases the amount of calculation. For this reason, there is a demand for further improvement in an active vibration noise controller which needs to generate a canceling sound in a short period of time.

An object of the present proposal is to provide an active vibration noise controller which can stably and effectively reduce noise by removing a voice component without largely increasing the amount of calculation.

To solve the above-described problems, an active vibration noise controller of the present invention comprises: a speaker which outputs a canceling sound for canceling noise; an error microphone which generates an error signal from the noise and the canceling sound; and a reference microphone which detects reference signals. In addition, the active vibration noise controller comprises a removal filter which is adaptively updated based on a current one of the reference signals and a previous one of the reference signals. The removal filter generates a removal signal from the previous reference signal, and generates the canceling sound by using a corrected reference signal obtained by removing the removal signal from the current reference signal.

According to the present invention, an active vibration noise controller which can stably and effectively reduce noise by removing a voice component without largely increasing the amount of calculation can be provided.

### BRIEF DESCRIPTION OF THE DRAWINGS

FIG. 1 is a schematic plan view of a vehicle to which an active vibration noise controller of a first embodiment is applied.

FIG. 2 is a block diagram showing functions of the active vibration noise controller of the first embodiment.

FIG. 3 is a functional block diagram showing a removal filter of the first embodiment.

FIG. 4 is a diagram showing a state in which a voice component lies over a microphone signal.

FIG. 5 is a diagram showing a state in which the voice component has been removed from the microphone signal.

FIG. 6 is a block diagram showing a configuration of a main part in an active vibration noise controller of a second embodiment.

FIG. 7 is a graph showing an example of a frequency band to be removed by a band-stop filter in the second embodiment.

FIG. 8 is a block diagram showing an entire configuration in an active vibration noise controller of a third embodiment.

### DETAILED DESCRIPTION OF THE EMBODIMENTS

Hereinafter, embodiments of the present invention will be described with reference to the drawing as appropriate. The same constituent elements are denoted by the same reference signs, and repetitive description will be omitted. Note that in the present Specification, “\hat{ }” (circumflex) stated together with various reference signs indicates an identified value or an estimated value. Although “\hat{ }” is attached above various reference signs in the drawings, “\hat{ }” is attached after various reference signs in the description.

### First Embodiment

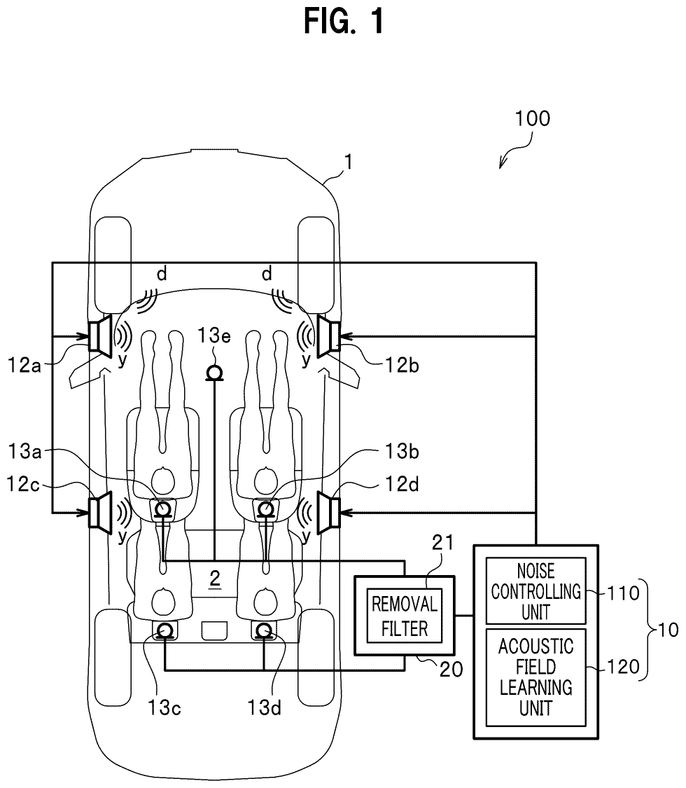

FIG. 1 shows a vehicle 1 to which an active vibration noise controller 100 (hereinafter, also abbreviated as a “noise controller 100”) according to the first embodiment is applied. In the description of the vehicle 1, the same elements are denoted by the same numbers, and repetitive description will be omitted. In addition, in the case of describing directions, the description will be made based on front, rear, left, right, up, and down as viewed from the driver of the vehicle 1. Note that a vehicle-width direction and a left-right direction have the same meaning.

The noise controller 100 is an ANC device (Active Noise Control Device) for reducing noise d generated in a vehicle interior 2 of the vehicle 1. More specifically, the noise controller 100 generates a canceling sound y which is opposite in phase to the noise d, and causes the canceling sound y thus generated to interfere with the noise d. In this way, the noise controller 100 can reduce the noise d to be reduced.

For example, the noise d to be reduced by the noise controller 100 is road noise which is attributable to vibration of wheels caused by forces from road surfaces. Note that the noise d to be reduced by the noise controller 100 may be noise other than road noise (for example, drive noise attributable to vibrations of a drive source such as an internal combustion engine or an electric motor, or wind noise, or the like).

The noise controller 100 of the first embodiment shown in FIG. 1 includes a plurality of speakers 12a-12d which output the canceling sound y for canceling the noise d. Moreover, the noise controller 100 includes a plurality of error microphones 13a-13d which generate an error signal e from the noise d and the canceling sound y. In addition, the noise controller 100 includes a reference microphone 13e which detects a reference signal r.

Moreover, the noise controller 100 includes a filter processing unit 10 and a voice removal unit 20. Note that the filter processing unit 10 and the voice removal unit 20 may be included for each of the speakers 12a-12d or the error microphones 13a-13d.

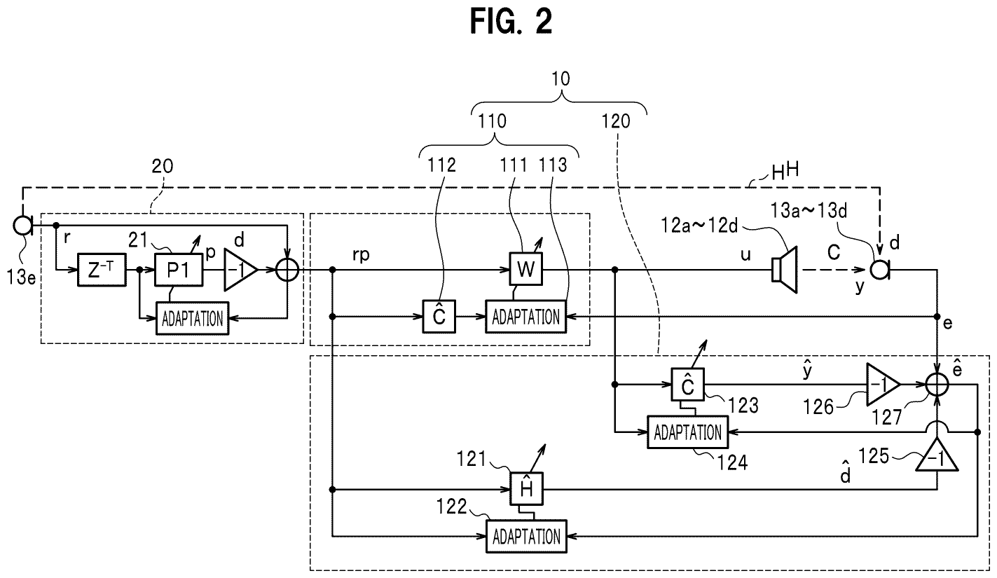

As shown in FIG. 2, the filter processing unit 10 includes a noise controlling unit 110 and an acoustic field learning unit 120. The noise controlling unit 110 and the acoustic field learning unit 120 are configured with a computer having an arithmetic processing unit (a processor such as a CPU (Central Processing Unit) or an MPU (Micro Processing Unit)) and a storage device (a memory such as a ROM (Read Only Memory) or a RAM (Random Access Memory)) or the like, for example.

In addition, in the noise controller 100, the configurations of the voice removal unit 20, the noise controlling unit 110, and the acoustic field learning unit 120 other than the speakers 12a-12d, the error microphones 13a-13d, and the reference microphone 13e may be configured, for example, as a single piece of hardware, or may be configured as a unit composed of a plurality of pieces of hardware.

Among these, the noise controlling unit 110 is configured to include mainly a noise control filter 111, a secondary path filter unit 112, and a control update unit 113.

Into the noise controlling unit 110, a corrected reference signal rp which is sent from the voice removal unit 20 is inputted in place of the reference signal r corresponding to the noise d.

The noise control filter 111 generates a control signal u from the corrected reference signal rp.

When inputted into each speaker 12a-12d, the control signal u controls and causes each speaker 12a-12d to output the canceling sound y.

The noise control filter 111 of the first embodiment falls into, for example, a FIR (Finite Impulse Response) filter. A FIR filter is a type of digital filter, and is a filter whose impulse response is of finite duration. In other words, the FIR filter is a filter in which an output signal (impulse response) converges within a finite time upon input of an impulse signal.

In addition, the secondary path filter unit 112 is configured with a secondary path filter having a filter characteristic C\hat{ }. The secondary path filter is a filter having a filter characteristic C corresponding to an estimated value of a transmission characteristic of a canceling sound y from the speakers 12a-12d to the error microphones 13a-13d. As the secondary path filter, a FIR filter may be used, or a SAN (Single Frequency Adaptive Notch) filter which is a single-tap adaptive filter specialized for a cyclic noise may be used.

Moreover, the control update unit 113 adaptively updates the filter characteristic W of the noise control filter 111 by using an adaptation algorithm such as a LMS algorithm (Least Mean Square Algorithm).

Into the control update unit 113, the corrected reference signal rp generated by the voice removal unit 20 and the error signal e generated by the error microphones 13a-13d are inputted.

Then, the control update unit 113 adaptively updates the filter characteristic W of the noise control filter 111 such that the error signal e is minimized by the corrected reference signal rp.

In this way, the noise control filter 111 can filter-process the corrected reference signal rp by using the adaptively updated filter characteristic W to generate a control signal u for controlling the output of the speakers 12a-12d.

Then, the noise control filter 111 outputs the control signal u thus generated to the speakers 12a-12d. The speakers 12a-12d can generate a canceling sound y in accordance with the control signal u, and effectively reduce the noise d inside the vehicle interior 2.

In addition, into the acoustic field learning unit 120 of the noise controller 100, the corrected reference signal rp sent from the voice removal unit 20 is inputted.

The acoustic field learning unit 120 includes a primary path filter unit 121 and a primary path update unit 122. Then, the acoustic field learning unit 120 is configured such that the corrected reference signal rp is inputted into the primary path filter unit 121 and the primary path update unit 122.

Moreover, into the acoustic field learning unit 120, the control signal u generated in the noise control filter 111 is inputted.

The acoustic field learning unit 120 includes a secondary path filter unit 123 and a secondary path update unit 124.

Then, the acoustic field learning unit 120 is configured such that the control signal u is inputted into the secondary path filter unit 123 and the secondary path update unit 124.

In addition, the acoustic field learning unit 120 is provided with a first polarity reversing unit 125, a second polarity reversing unit 126, and an adder 127. The first polarity reversing unit 125 reverses the polarity of the noise signal d\hat{ } inputted from the primary path filter unit 121 and sends the noise signal d\hat{ } to the adder 127.

Moreover, the second polarity reversing unit 126 reverses the polarity of a canceling sound signal y\hat{ } of the canceling sound y inputted from the secondary path filter unit 123 and sends the canceling sound signal y\hat{ } to the adder 127.

The adder 127 obtains an error signal e\hat{ } by adding the noise signal d\hat{ } having the reversed polarity, the canceling sound signal y\hat{ } having the reversed polarity, and the error signal e generated by the error microphones 13a-13d. The error signal e\hat{ } is sent to the primary path update unit 122 and the secondary path update unit 124, and is used for adaptive update in the primary path filter unit 121 and the secondary path filter unit 123.

The voice removal unit 20 of the first embodiment is provided on the input side of the filter processing unit 10. Into this voice removal unit 20, a current reference signal r(t) is inputted from the reference microphone 13e.

Then, the voice removal unit 20 generates a corrected reference signal rp obtained by removing a removal signal p from the current reference signal r(t) by using a removal filter 21.

In this way, the voice removal unit 20 can send the corrected reference signal rp composed of a signal of a noise component from which a signal of a voice component has been removed to the noise controlling unit 110 and the acoustic field learning unit 120 of the filter processing unit 10.

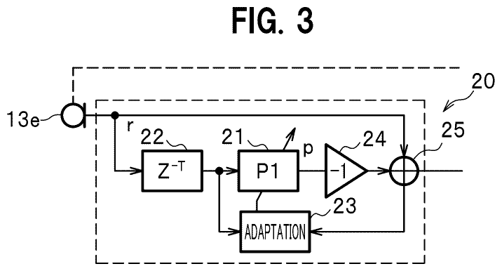

Specifically, as shown in FIG. 3, the voice removal unit 20 of the first embodiment is provided with the removal filter 21 and a delay processing unit 22 which conducts delay processing (Z-T).

Moreover, the voice removal unit 20 is provided with an adaptive update unit 23. The adaptive update unit 23 adaptively updates the removal filter 21 based on the current reference signal r(t) inputted from the reference microphone 13e and a previous reference signal r(t-T) subjected to delay processing in the delay processing unit 22.

In the first embodiment, the adaptive update unit 23 refers to the previous reference signal r(t-T) and the corrected reference signal (rp) obtained by removing the voice component from the current reference signal r.

For this, the voice removal unit 20 is provided with a polarity reversing unit 24 and an adder 25. The polarity reversing unit 24 reverses the polarity of a periodic removal signal p (voice signal) which is sent from the removal filter 21. The polarity reversing unit 24 outputs the removal signal p having the reversed polarity to the adder 25. In this way, the voice removal unit 20 of the first embodiment can output a corrected reference signal rp from which the voice component has been removed by using the removal filter 21 which has been adaptively updated by the adaptive update unit 23.

The removal filter 21 of the first embodiment is an FIR (Finite Impulse Response) filter for predicting voice having a plurality of frequency components. In addition, as the removal filter 21, an IIR (Infinite Impulse Response) filter P1 may be used. An FIR filter is a type of digital filter, and is a filter whose impulse response is of finite duration. In other words, the FIR filter is a filter in which an output signal (impulse response) converges within a finite time upon input of an impulse signal.

The removal filter 21 extracts a periodic signal contained in the previous reference signal r(t-T) to obtain a removal signal p. Moreover, the removal filter 21 generates a corrected reference signal rp obtained by removing the removal signal p from the current reference signal r(t).

In general, an output p (t) of a prediction filter serving as a removal filter is calculated like Formula (1) from a reference signal r which has been delayed by time T.

$$\begin{matrix}[ Math . 1 ] & \\ p ( t ) = r ( t - T ) * P ( t ) & Formula ( 1 )\end{matrix}$$

Here, T: delay time, t: discrete time, *: convolution operation.

An error signal ep for adaptive update of the prediction filter is a difference between the current reference signal r(t) and the output p (t) from the prediction filter, and is thus expressed by the following Formula (2).

$$\begin{matrix}[ Math . 2 ] & \\ ep ( t ) = r ( t ) - p ( t ) & Formula ( 2 )\end{matrix}$$

Once the error signal ep converges into 0, the output p (t) becomes the current reference signal r. That is, it can be understood that the linear prediction filter which is adaptively updated is a filter for predicting a current reference signal r(t) from a previous reference signal r(t-T).

For an algorithm for separating general voice and environmental noise, it is necessary to use a plurality of microphones, leading to an expensive system. In addition, for signal processing as well, operation in a frequency domain using a plurality of times of convolution operation, DFT (Discrete Fourier Transform), FFT (Fast Fourier Transform), or the like is conducted, so that the amount of calculation is large. Such an algorithm having a large amount of calculation has a problem that it takes time to separate voice and an environmental noise. In addition, a high-performance processor which can execute an algorithm in a short period of time is expensive, and is thus not suitable for noise removal of the vehicle 1 with which an increase in manufacturing cost needs to be suppressed.

For this reason, the present proposal has focused on the fact that it is possible to effectively separate voice and environmental noise such as interior noise by utilizing characteristics of voice as a measure which requires a small amount of calculation and small delay due to processing.

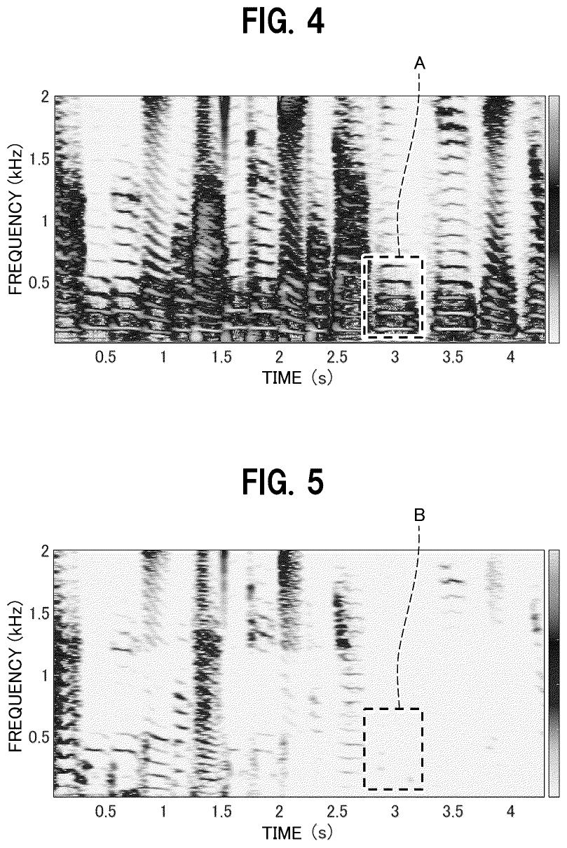

FIG. 4 shows a state in which a voice component lies over a component of an environmental noise of a microphone signal.

In FIG. 4, the vertical axis indicates frequency (kHz), and the horizontal axis indicates time(s), and it is visualized in difference in gradation such that portions of thick color (black) have larger sound volume (dB) than portions of thin color (white).

Here, a voice component is a combination of a plurality of periodic sounds as shown in A portion, for example. The periodicity is known to be caused by resonant frequencies (formant frequencies) due to the vocal cords and the structure of the mouth of human, and harmonic sounds thereof. Although formant frequencies are different depending on individual differences of speakers and syllables, there is no difference in that any voice has a periodicity due to a combination of the formant frequency and the harmonic sound thereof.

In contrast, the interior noise of the vehicle 1 has characteristics different from voice components. For example, in an electric travel mode of an electric vehicle or a hybrid vehicle, there is no noise source having strong periodicity like an engine sound and the like. Then, noise inside the vehicle interior 2 is dominated by road noise and aerodynamic noise, and thus becomes noise having strong randomness.

FIG. 5 shows mainly components of interior noise which do not contain voice components in a microphone signal. When FIG. 5 is compared with FIG. 4, There is no voice component which is a combination of a plurality of periodic sounds from B portion of FIG. 5, which corresponds to A portion of FIG. 4.

That is, the noise controller 100 needs to separate voice having periodicity from noise having a large amount of random noise in order to obtain a control signal u suitable for a canceling sound.

Here, voice has periodicity, and is thus a predictable sound. On the other hand, interior noise has strong randomness, and is thus unpredictable. The present proposal has embodied a countermeasure for reducing noise focusing on such a difference in periodicity.

That is, it is considered that the noise controller 100 of the first embodiment can extract and separate predictable voice components from interior noise by using an adaptive linear prediction filter.

Specifically, the removal filter 21 provided in the voice removal unit 20 of the first embodiment extracts a periodic signal contained in a previous reference signal r(t-r) as a removal signal p. The removal signal p is a predictable voice component among the reference signals r. Hence, by removing the removal signal p from a current reference signal r(t), an unpredictable noise component remains, and a corrected reference signal rp is generated.

In addition, the removal filter 21 of the first embodiment has very short delay due to filtering processing, can thus cancel noise in real-time, and is suitable for removing a signal of voice component.

In this way, the noise controller 100 of the first embodiment uses a corrected reference signal rp generated by the voice removal unit 20 in place of a reference signal r which is directly inputted from the reference microphone 13e. The corrected reference signal rp is mainly generated with only noise components from which a voice component has been removed.

In this way, the noise controlling unit 110 of the filter processing unit 10 can easily generate a control signal u which is effective only for noise with a small amount of calculation without increasing the amount of calculation.

The noise controlling unit 110 of the filter processing unit 10 generates a control signal u by using the corrected reference signal rp which does not contain a signal of voice component generated by the voice removal unit 20. Hence, in the vehicle 1 of the first embodiment, the canceling sound y which is effective only for noise is timely outputted from each speaker 12a-12d due to the noise control by the noise controller 100.

For this reason, it is possible to stably and effectively reduce noise while suppressing echoes of voices. Hence, the vehicle 1 of the first embodiment can create a space with high quietness, comfort, and high quality inside the vehicle interior 2.

### Second Embodiment

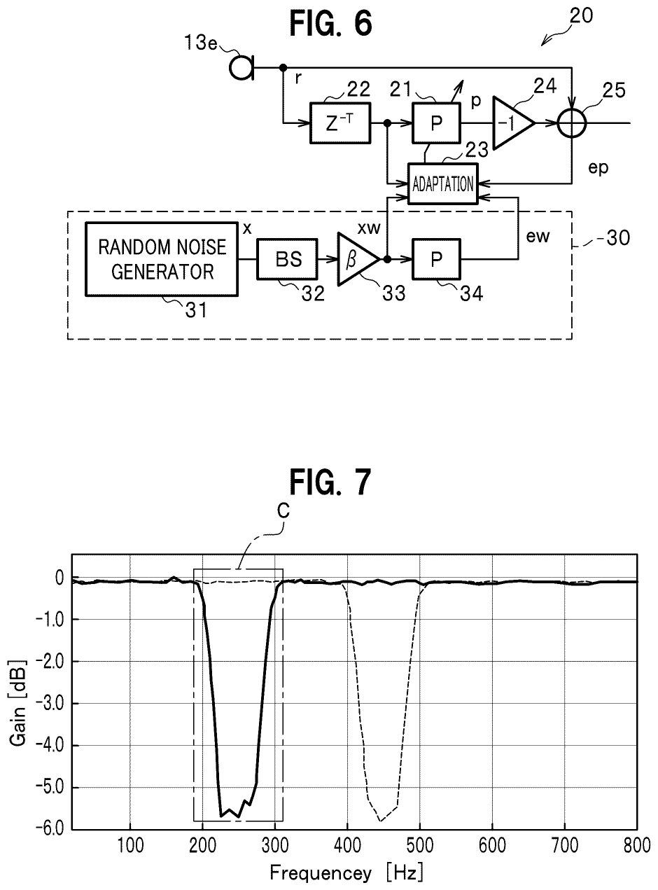

FIG. 6 is a block diagram showing an active vibration noise controller 200 (hereinafter, also abbreviated as a “noise controller 200”) of a second embodiment for describing a configuration of a main part. Note that the same or equivalent parts as those of the active vibration noise controller 100 of the aforementioned first embodiment are denoted by the same reference signs, and description thereof will be omitted.

The noise controller 200 of the second embodiment includes a band removal unit 30 which is provided with a band-stop filter 32 and removes a specific frequency band.

The band removal unit 30 includes a random noise generator 31 which generates random noise x non-correlated with other signals and the band-stop filter 32 which stops passage of a desired frequency band in the random noise x.

In addition, the band removal unit 30 includes a gain amplifying unit 33 which adjusts the gain of a band removal signal xw to be sent to the adaptive update unit 23 of the voice removal unit 20 and a sub-removal filter 34 which generates an error signal ew corresponding to an output outside a removal band from the band removal signal xw and sends the error signal ew to the adaptive update unit 23.

Then, in the noise controller 200 of the second embodiment, the adaptive update unit 23 of the voice removal unit 20 is configured such that the band removal signal xw which contains random noise and has been passed through the band-stop filter 32 and the error signal ew are further added thereto, and the adaptive update unit 23 adaptively updates the removal filter 21.

Specifically, the band-stop filter 32 of the noise controller 200 stops random noise only for a frequency band in which voice echo becomes a problem. In this way, an influence of voice removal processing can be limited.

That is, the evaluation function for adaptively updating the removal filter 21 is expanded in the following Formula (3).

$$\begin{matrix}[ Math . 3 ] & \\ J = ep \hat{} 2 + ew \hat{} 2 & Formula ( 3 )\end{matrix}$$

Here, in Formula (3), ew=x*BS*p. In addition, the BS (band-stop filter 32) transmits signals in bands other than the band in which voice is desired to be removed. Hence, the error signal ew corresponds to the output of the removal filter 21 outside the removal band.

Since the noise controller 200 of the second embodiment conducts adaptive update such that the above-described evaluation function becomes the minimum (0), the noise controller 200 attempts to simultaneously make ep and ew 0. By reducing ew, the noise controller 200 can suppress the output of the removal filter 21 outside the removal band.

In addition, by reducing ep, the noise controller 200 can extract a periodic voice component contained in the reference signal. The update formula of the removal filter 21 based on this evaluation function is the following Formula (4).

$$\begin{matrix}[ Math . 4 ] & \\ p ( t + 1 ) = P ( t ) + μ ep ( t ) r ( t - T ) + β ew ( t ) xw ( t ) & Formula ( 4 )\end{matrix}$$

For this reason, in the frequency band which has been removed by the band-stop filter 32, a voice component can be extracted and outputted by the adaptive update of the removal filter 21. In the frequency band which has not been removed by the band-stop filter 32, the update of the removal filter 21 is suppressed, so that the output is small.

Hence, the removal filter 21 is adaptively updated by using the error signal ew which has been passed through the band-stop filter 32 to contain a random noise together with the previous reference signal r(t-T) sent from the delay processing unit 22. By using the removal filter 21 thus adaptively updated, in the frequency band which has been removed by the band-stop filter 32, a corrected reference signal rp obtained by removing the periodic voice component from the reference signal r can be generated. In addition, in the frequency band which has not been removed by the band-stop filter 32, the output of the removal filter 21 is suppressed, so that an influence on the reference signal r is small.

In this way, the noise controller 200 of the second embodiment can effectively remove only the frequency band in which a voice echo occurs by using the band removal unit 30 including the band-stop filter 32. For this reason, the noise controller 200 can further limit the influence associated with the voice-removal processing.

FIG. 7 is a graph showing an example of a frequency band to be removed by the band-stop filter 32 in the second embodiment. In FIG. 7, C portion, which is the removal region, is set to a frequency band in which voice is desired to be removed. In this way, by setting the removal region to a frequency band in which the amount of voice component is largest, the noise controller 200 can more surely remove the voice component in the removal filter 21.

For this reason, it is possible to remove voice only for a frequency component which gives discomfort to an occupant due to an influence of voice (echo), and to reduce an influence due to the voice removal processing in the other frequency band as much as possible.

Since the other configurations and the actions and effects are the same as those in the first embodiment, description thereof will be omitted.

### Third Embodiment

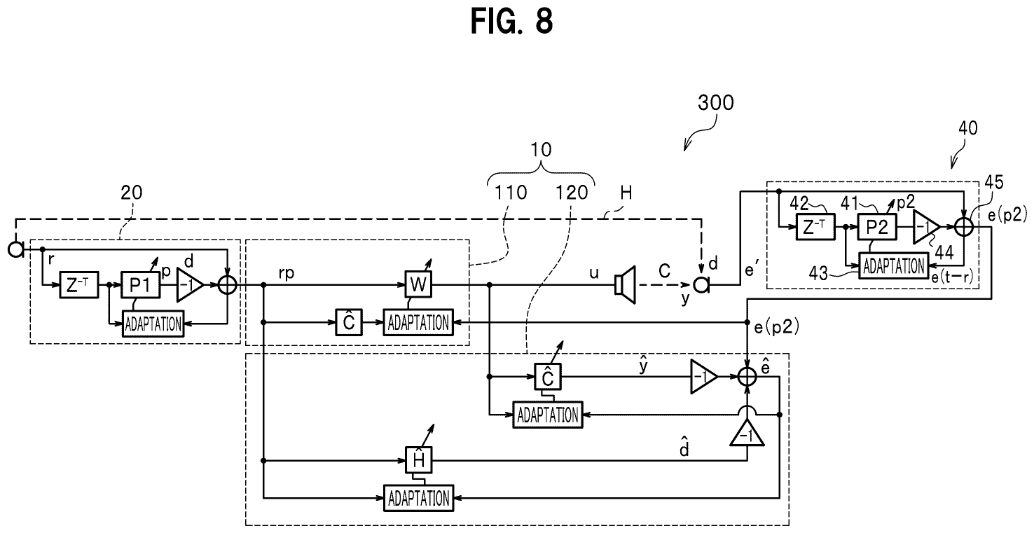

FIG. 8 is a block diagram showing an active vibration noise controller 300 (hereinafter, also abbreviated as a “noise controller 300”) of a third embodiment for describing an entire configuration. Note that the same or equivalent parts as those of the active vibration noise controller 100 of the first embodiment are denoted by the same reference signs, and description thereof will be omitted.

The noise controller 300 of the third embodiment includes a second voice removal unit 40. The second voice removal unit 40 includes a second removal filter 41 which is adaptively updated based on a current error signal e′ (t) and a previous error signal e′ (t-T).

Specifically, the second voice removal unit 40 includes the second removal filter 41, a second delay processing unit 42, a second adaptive update unit 43, a polarity reversing unit 44, and an error adder 45.

The second voice removal unit 40 is connected to the error microphones 13a-13d, and the error signals e′ sent from the error microphones 13a-13d are inputted into the second voice removal unit 40.

The second voice removal unit 40 is provided with the second adaptive update unit 43 which adaptively updates the second removal filter 41 by using the previous error signal e′ (t-T) sent from the second delay processing unit 42. In addition, the polarity reversing unit 44 reverses the polarity of a second removal signal p2 outputted from the second adaptive update unit 43, and sends the second removal signal p2 to the error adder 45.

The error adder 45 generates a corrected error signal e (p2) by adding the current error signal e′ (t) and the second removal signal p2 having the reversed polarity. The corrected error signal e (p2) is sent to the noise controlling unit 110 and the acoustic field learning unit 120 which are configured in the same manner as in the first embodiment, and is used for adaptive update of each filter.

In the noise controller 300 of the third embodiment configured as described above, the second removal filter 41 extracts a periodic signal contained in the previous error signal e′ (t-T) to obtain the second removal signal p2. In addition, the second removal filter 41 generates the corrected error signal e (p2) obtained by removing the second removal signal p2 from the current error signal e′. Then, the filter processing unit 10 is adaptively updated based on the corrected error signal e (p2).

For this reason, the noise controller 300 of the third embodiment can effectively remove a periodic voice signal also from the error signal e′. Therefore, the noise controller 300 of the third embodiment exerts practically useful actions and effects such as being capable of stably and effectively reducing noise by adaptively updating the filter processing unit 10 with higher accuracy.

Since the other configurations and the actions and effects are the same as those in the first embodiment, description thereof will be omitted.

As described above, the present proposal includes the speakers 12a-12d which output a canceling sound for cancelling noise, the error microphones 13a-13d which generates an error signal from the noise d and the canceling sound y, and the reference microphone 13e which detects a reference signal like the active vibration noise controller (noise controller) 100 of the first embodiment which is shown in FIG. 1.

In addition, as shown in FIG. 2, the noise controller 100 includes the removal filter 21 which is adaptively updated based on a current reference signal and a previous reference signal. The removal filter 21 generates a removal signal from the previous reference signal, and generates a canceling sound by using a corrected reference signal obtained by removing the removal signal from the current reference signal.

In this way, the noise controller 100 can stably and effectively reduce noise by removing a voice component without largely increasing the amount of calculation.

Specifically, for example, the removal filter 21 may extract a periodic signal contained in a previous reference signal to obtain a removal signal p, and generate a corrected reference signal rp obtained by removing the removal signal P from a current reference signal. Then, the noise control filter 111 generates a canceling sound y by using the corrected reference signal rp.

As shown in FIG. 3, the removal filter 21 used in the voice removal unit 20 of the present proposal extracts a periodic voice signal contained in a previous reference signal r(t-T) for obtaining a removal signal p. Then, the removal filter 21 is adaptively updated by the adaptive update unit 23 based on the current reference signal r(t) and the previous reference signal r(t-T). The voice removal unit 20 can extract a predictable periodic voice component by the adaptive update of the removal filter 21.

This makes it possible to obtain a removal signal p to be removed from a current reference signal r(t) and generate a corrected reference signal rp obtained by removing the removal signal p from the current reference signal r(t) in a short period of time with a small amount of calculation.

Then, the noise control filter 111 outputs, from the speakers 12a-12d, a canceling sound y from which a voice component has been removed by using the corrected reference signal rp. In this way, noise d which is random noise, is reduced. In addition, the canceling sound y does not contain a voice component. For this reason, there is no influence of interference due to a voice component. Hence, voice echo inside the vehicle interior 2 can be reduced to eliminate discomfort given to the occupant.

Therefore, the noise controller 100 of the present proposal can stably and effectively reduce noise by removing a voice component without largely increasing the amount of calculation.

In addition, the present proposal includes the band-stop filter 32 which removes a specific frequency band like the noise controller 200 shown in FIG. 6. The removal filter 21 is adaptively updated by further adding random noise which has been passed through the band-stop filter 32.

For this reason, in a frequency band which has been removed by the band-stop filter 32, a voice component can be extracted and outputted by the adaptive update of the removal filter 21. In a frequency band which has not been removed by the band-stop filter 32, the update of the removal filter 21 is suppressed, so that the output is small.

Hence, the removal filter can generates a corrected reference signal by extracting a voice component only within a frequency band in which an echo occurs due to the influence of a voice.

For this reason, only the frequency band in which a voice echo occurs can be effectively removed by the band-stop filter 32, so that an influence associated with voice-removal processing can be limited.

Then, the present proposal includes the second removal filter 41 which is adaptively updated based on a current error signal e′ (t) and a previous error signal e′ (t-T) like the noise controller 300 shown in FIG. 8.

The second removal filter 41 generates a second removal signal p2 from a previous error signal e′ (t-T). In addition, the second removal filter 41 generates a corrected error signal e (p2) obtained by removing the second removal signal p2 from the current error signal e′ (t-T). Then, the filter processing unit 10 is adaptively updated based on the corrected error signal e (p2).

For this reason, the noise controller 300 can effectively remove a periodic voice signal also from an error signal e′.

Therefore, the noise controller 300 can exerts practically useful actions and effects such as being capable of adaptively updating the filter processing unit 10 with higher accuracy.

The present invention is not limited to the above-mentioned embodiments, and various modifications can be made. The above-mentioned embodiments are shown as examples for describing the present invention in an easily understandable manner, and the present invention is not necessarily limited to those including all the configurations described above. In addition, it is possible to replace part of the configuration of a certain embodiment with the configuration of another embodiment, and it is also possible to add, to the configuration of a certain embodiment, the configuration of another embodiment. In addition, it is possible to delete part of the configuration of each embodiment, or add another configuration to the configuration or replace the configuration with another configuration. Possible modifications for the above-described embodiments are as described below, for example.

That is, the noise controller 200 of the second embodiment includes the band removal unit 30, and the noise controller 300 of the third embodiment includes the second voice removal unit 40. However, the present proposal is not particularly limited to these. For example, both of the band removal unit 30 and the second voice removal unit 40 may be included in a single active vibration noise controller.

In this way, as long as the active vibration noise controller of the present proposal includes the filter processing unit 10 and the removal filter 21 as in the first embodiment, the other configurations which exert the respective functions and combinations of these other configurations are not limited to the configurations of the first to third embodiments.

What is claimed is:

1. An active vibration noise controller comprising:
a speaker which outputs a canceling sound for canceling noise;
an error microphone which generates an error signal from the noise and the canceling sound;
a reference microphone which detects reference signals; and
a removal filter which is adaptively updated based on a current one of the reference signals and a previous one of the reference signals, wherein
the removal filter generates a removal signal from the previous reference signal, and generates the canceling sound by using a corrected reference signal obtained by removing the removal signal from the current reference signal.

2. The active vibration noise controller according to claim 1, further comprising a band-stop filter which removes a specific frequency band, wherein
the removal filter is adaptively updated by further adding random noise which has been passed through the band-stop filter.

3. The active vibration noise controller according to claim 1, further comprising a second removal filter which is adaptively updated based on the current error signal and the previous error signal, wherein
the second removal filter generates a second removal signal from the previous error signal, and generates a corrected error signal obtained by removing the second removal signal from the current error signal, and
the filter processing unit is adaptively updated based on the corrected error signal.
